(19) United States
(12) Patent Application Publication
(10) Pub. No.: US 2016/0063095 A1
(43) Pub. Date: Mar. 3, 2016

(54) UNSTRUCTURED DATA GUIDED QUERY MODIFICATION

(71) Applicant: International Business Machines Corporation, Armonk, NY (US)

(72) Inventors: AHMED M.A. NASSAR, Katy, TX (US); Eman Omar, Katy, TX (US); Evelyn M. Rosengarten, Saint Charles, MO (US); Craig M. Trim, Los Angeles, CA (US)

(21) Appl. No.: 14/469,705

(22) Filed: Aug. 27, 2014

(51) Int. Cl. G06F 17/30; G06F 17/27

(52) U.S. Cl. CPC G06F 17/30684; G06F 17/30424; G06F 17/277

(57) ABSTRACT

A method, system, and computer program product for unstructured data guided query modification are provided in the illustrative embodiments. A set of parameters is identified in a structured database query. Using a Natural language processing (NLP) engine, a set of tokens is identified in an unstructured data. Using the NLP engine, corresponding to a subset of the set of parameters, sets of variations are obtained. A fit is found between a first token from the set of tokens and a first variant of a first parameter, the first variant of the first parameter being a member of a first set of variations corresponding to the first parameter. The first parameter in the structured database query is substituted with the first variant to produce a substituted query, wherein the substituted query produces a result set that is related to the unstructured data.

### TECHNICAL FIELD

The present invention relates generally to a method, system, and computer program product for modifying a database query. More particularly, the present invention relates to a method, system, and computer program product for unstructured data guided query modification.

### BACKGROUND

Structured data is data that conforms to an organization defined by a specification. In a data fragment of a structured data, the content of the data fragment has meaning or significance not only from the literal interpretation of the content of the fragment, but also from the form, location, and other organization-specific attributes of the fragment.

A database query is an example of structured data, where the construct of the query conforms to a specification such as structured Query Language (SQL). Query fragments having specific forms or occupying specific position in the query carry specific meanings owing to such form or position.

In contrast, unstructured data is data that does not conform to any particular organization and position or form of the content in a data fragment of unstructured data generally does not contribute to the meaning or significance of the content.

Voice over Internet protocol (VoIP) data, conversational text or speech data, social media interactions, and the like are some examples of unstructured data. For example, a sentence spoken or written on social media has meaning according to the literal interpretation of the data of the sentence, and a word in the sentence does not acquire any additional meaning or significance according to some specification by being positioned in a specific location in the sentence.

Social media comprises any medium, network, channel, or technology for facilitating communication between a number of individuals and/or entities (users). Some common examples of social media are Facebook or Twitter, each of which facilitates communications in a variety of forms between large numbers of users (Facebook is a trademark of Facebook, Inc. in the United States and in other countries. Twitter is a trademark of Twitter Inc. in the United States and in other countries.) Social media, such as Facebook or Twitter allow users to interact with one another individually, in a group, according to common interests, casually or in response to an event or occurrence, and generally for any reason or no reason at all.

Some other examples of social media are websites or data sources associated with radio stations, news channels, magazines, publications, blogs, and sources or disseminators of news or information. Some more examples of social media are websites or repositories associated with specific industries, interest groups, action groups, committees, organizations, teams, or other associations of users.

Data from social media comprises unidirectional messages, or bi-directional or broadcast communications in a variety of languages and forms. Such communications in the social media data can include proprietary conversational styles, slangs or acronyms, urban phrases in a given context, formalized writing or publication, and other unstructured data.

Natural language processing (NLP) is a technique that facilitates exchange of information between humans and data processing systems. For example, one branch of NLP pertains to answering questions about a subject matter based on information available about the subject matter domain.

Information about a domain can take many forms and can be sourced from any number of data sources. The presenter of the information generally selects the form and content of the information. Before information can be used for NLP, generally, the information has to be transformed into a form that is usable by an NLP engine.

### SUMMARY

The illustrative embodiments provide a method, system, and computer program product for unstructured data guided query modification. An embodiment includes a method for unstructured data guided query modification. The embodiment identifies, using a processor and a memory, a set of parameters in a structured database query. The embodiment identifies, using a Natural language processing (NLP) engine, a set of tokens in an unstructured data. The embodiment obtains, using the NLP engine, corresponding to a subset of the set of parameters, sets of variations, wherein a particular set of variations corresponds to a particular parameter in the subset of parameters. The embodiment finds a fit between a first token from the set of tokens and a first variant of a first parameter, the first variant of the first parameter being a member of a first set of variations corresponding to the first parameter. The embodiment substitutes the first parameter in the structured database query with the first variant to produce a substituted query, wherein the substituted query produces a result set that is related to the unstructured data.

Another embodiment includes a computer program product for unstructured data guided query modification. The embodiment further includes one or more computer-readable tangible storage devices. The embodiment further includes program instructions, stored on at least one of the one or more storage devices, to identify, using a processor and a memory, a set of parameters in a structured database query. The embodiment further includes program instructions, stored on at least one of the one or more storage devices, to identify, using a Natural language processing (NLP) engine, a set of tokens in an unstructured data. The embodiment further includes program instructions, stored on at least one of the one or more storage devices, to obtain, using the NLP engine, corresponding to a subset of the set of parameters, sets of variations, wherein a particular set of variations corresponds to a particular parameter in the subset of parameters. The embodiment further includes program instructions, stored on at least one of the one or more storage devices, to find a fit between a first token from the set of tokens and a first variant of a first parameter, the first variant of the first parameter being a member of a first set of variations corresponding to the first parameter. The embodiment further includes program instructions, stored on at least one of the one or more storage devices, to substitute the first parameter in the structured database query with the first variant to produce a substituted query, wherein the substituted query produces a result set that is related to the unstructured data.

Another embodiment includes a computer system for unstructured data guided query modification. The embodiment further includes one or more processors, one or more computer-readable memories and one or more computer-readable tangible storage devices. The embodiment further includes program instructions, stored on at least one of the one or more storage devices for execution by at least one of the one or more processors via at least one of the one or more memories, to identify, using a processor and a memory, a set of parameters in a structured database query. The embodiment further includes program instructions, stored on at least one of the one or more storage devices for execution by at least one of the one or more processors via at least one of the one or more memories, to identify, using a Natural language processing (NLP) engine, a set of tokens in an unstructured data. The embodiment further includes program instructions, stored on at least one of the one or more storage devices for execution by at least one of the one or more processors via at least one of the one or more memories, to obtain, using the NLP engine, corresponding to a subset of the set of parameters, sets of variations, wherein a particular set of variations corresponds to a particular parameter in the subset of parameters. The embodiment further includes program instructions, stored on at least one of the one or more storage devices for execution by at least one of the one or more processors via at least one of the one or more memories, to find a fit between a first token from the set of tokens and a first variant of a first parameter, the first variant of the first parameter being a member of a first set of variations corresponding to the first parameter. The embodiment further includes program instructions, stored on at least one of the one or more storage devices for execution by at least one of the one or more processors via at least one of the one or more memories, to substitute the first parameter in the structured database query with the first variant to produce a substituted query, wherein the substituted query produces a result set that is related to the unstructured data.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts an example configuration for unstructured data guided query modification in accordance with an illustrative embodiment;

FIG. 4 depicts a block diagram of an example unstructured data guided query modification in accordance with an illustrative embodiment; and

FIG. 5 depicts a flowchart of an example process for unstructured data guided query modification in accordance with an illustrative embodiment.

### DETAILED DESCRIPTION

Targeted marketing is an example area that recognizes the importance of presenting results relevant to a user's interest. For example, a company may have a product portfolio of hundreds or thousands of products, but advertising or offering each product to each potential customer is cumbersome, inefficient, and often counterproductive. A user is more likely to be converted into a customer if the products presented for the user's consideration are relevant to the user's preferences.

Creating structured profiles of users, identifying and categorizing their interests, and matching offerings to such profiles is known in the prior art. In fact an entire industry exists to create and manage such structured profiles, and provide the product-profile matching services.

The illustrative embodiments recognize that regardless of systematically created and managed structured profiles, a user's interests or expectations are transient and dynamic. In other words, a user's interest or expectation is influenced by the circumstances of the user, as they change over time, as they are influenced by events occurring relative to the user, and according to many other factors.

The illustrative embodiments further recognize that unstructured data used or contributed by the user, such as in audio/video communications, social media messages, writing or other textual content, and the like, is indicative of the state of the user's dynamic circumstances. Accordingly, the illustrative embodiments further recognize that such unstructured data is also indicative of the user's transient and dynamic interests or expectations at different points in time.

The illustrative embodiments recognize that searching for information, products, or services according to the contents of a structured profile of a user is insufficient to meet the changing needs of the user. The illustrative embodiments recognize that the unstructured data produced or used by the user can be harnessed to perform searches for things that are related to the user's dynamic interests or expectations.

The illustrative embodiments used to describe the invention generally address and solve the above-described problems and other problems related to matching a user's dynamic interests with searchable data. The illustrative embodiments provide a method, system, and computer program product for unstructured data guided query modification.

An embodiment selects, identifies, or otherwise receives a query or query template (collectively hereinafter “original query”) from a query repository. The query comprises one or more parameters. A parameter of an original query is a query fragment that specifies what the original query is expected to search for when executed against a database. As obtained from the query repository, a parameter in the original query has a generic value, to wit, a value that is non-specific to any particular user's interest or expectation.

An embodiment isolates or extracts one or more parameters from the original query. The embodiment sends an extracted parameter to an NLP engine. The NLP engine, using one or more domain information sources, such as one or more ontologies, determines a set of variations that correspond to the parameter.

A variant in the set of variations is an alternate value of the parameter that meets or conforms to the scope of the generic value. For example, assume that the generic value of the parameter is “item_place”, i.e., a place or location of the item that the query is searching. Some variants of “item_place” are city, region, and country.

The NLP engine returns to the embodiment the set of variations corresponding to an extracted parameter. The original query includes a set of parameters, the set of parameters including any number of parameters. An embodiment can extract a subset of the set of the parameters, the subset including all or some of the parameters in the set. An embodiment obtains a set of variants for each parameter in a subset of the subset of parameters. The subset of the subset of parameters including all or some of the parameters in the subset of parameters. A set of variations can include any number of variants from any number of domain information sources within the scope of the illustrative embodiments.

An embodiment selects, identifies, or otherwise receives an instance of unstructured data, e.g., a sample unstructured data produced or used by a user. The embodiment obtains a set of tokens contained in the unstructured data. For example, the embodiment sends the unstructured data to the NLP engine. The NLP engine, using one or more domain information sources, such as one or more ontologies, identifies the tokens present in the unstructured data.

A token is a fragment of the unstructured data that is usable to identify an aspect of a user's dynamic interest or expectation. For example, suppose that the unstructured data comprises a sentence that mentions a particular place in some context, e.g., “I should check how she is doing in Beijing, perhaps send a gift to her there.” The place “Beijing” can be regarded as a token because it is usable as an aspect of the user's dynamic interest or expectation of inquiring about a person there, buying or sending a gift item there, or both. Sometimes, but not necessarily, a token is also usable in a query in the place of a parameter.

An embodiment finds a fit between a token in the unstructured data and a variant of a parameter of the original query. The fit can be an exact match or a match or correspondence within a specified semantic tolerance. For example, token “Beijing” obviously matches variant “Beijing” of parameter “item_place” if that variant is available in the set of variations of the parameter. Token “Beijing” fits variant “city” of parameter “item_place” within a semantic tolerance that provides that “city” encompasses specifically named towns or cities.

An embodiment further determines best fitting variant for a given token when the token fits more than one variant. For example, token “Beijing” also fits variant “region” of parameter “item_place” within a semantic tolerance that provides that “region” encompasses specifically named towns, cities, states, provinces, and other geographically defined regions. If both “city” and “region” variants are available, the embodiment determines that the token “Beijing” fits variant “city” more or better than variant “region.” Within the scope of the illustrative embodiments a semantic tolerance can be specified as computable logic, one or more values, regular expressions, or using any other suitable form.

Once an embodiment has identified a fitting variant for a given token in the unstructured data, the embodiment substitutes the corresponding parameter with the fitting variant. Operating in this manner, one or more embodiments cause one or more parameters in the original query to be substituted with corresponding variants that fit various tokens in the unstructured data.

Substituting the one or more parameters with corresponding fitting variants results in a substituted query. The substituted query can then be executed against a database of searchable data pertaining to information, products, or services. The result set generated from such a search will correspond with the dynamic interest or expectation of the user identified from the unstructured data.

A method of an embodiment described herein, when implemented to execute on a data processing system, comprises substantial advancement of the functionality of that data processing system in providing database services. For example, the illustrative embodiments enable the data processing system to present a search result set that corresponds to a user's time-based, event-based, circumstantial, or otherwise transient and dynamic interests and expectations . . . . Such manner of establishing correspondence between user's transient or dynamic interests or expectations and available data is unavailable in presently operating data processing systems that serve databases. Thus, a substantial advancement of such data processing systems by executing a method of an embodiment comprises delivery of search result sets that are relevant to a user's transient or dynamic interests or expectations regardless of any structured profile that may be available to the data processing system.

The illustrative embodiments are described with respect to certain structures, queries, databases, repositories, unstructured data, parameters, variations or variants, tokens, NLP methodologies, domains and domain information, tolerances, policies, logic, rules, data processing systems, environments, components, and applications only as examples. Any specific manifestations of such artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

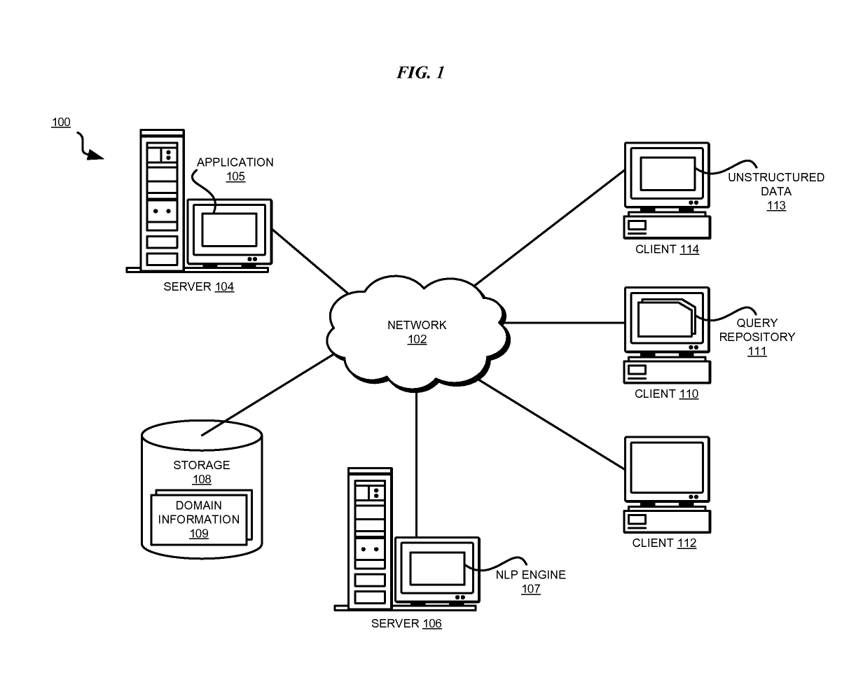

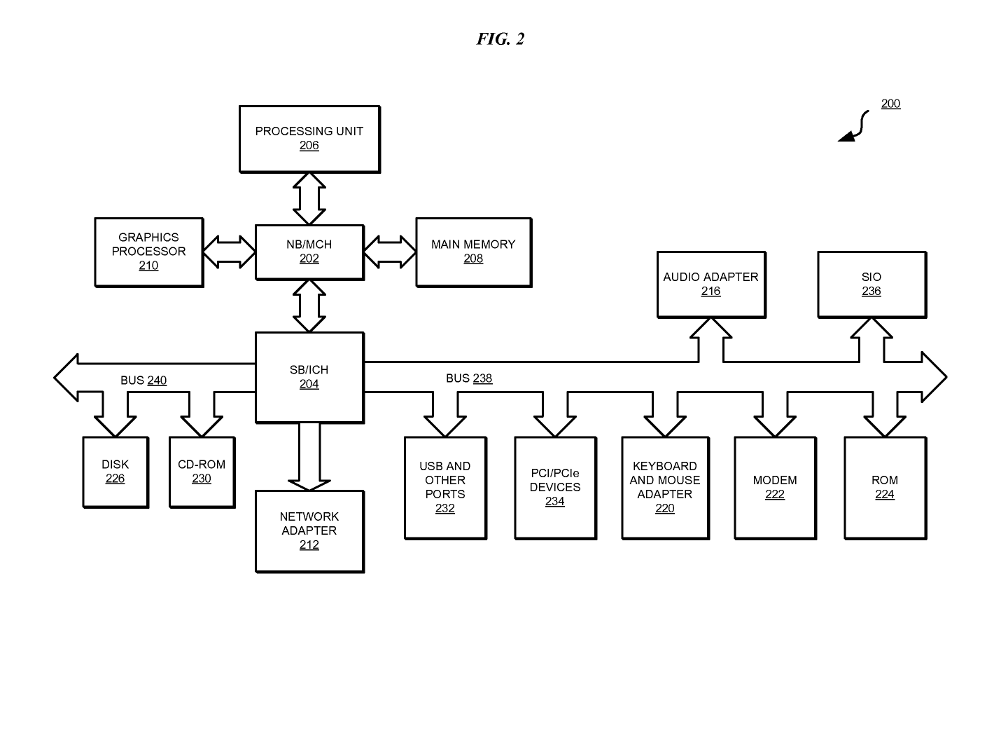

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments.

Application 105 implements an embodiment described herein. NLP engine 107 is any suitable existing NLP engine. Domain information 109 is any suitable form of domain information usable by NLP engine 107. Any suitable type and number of domain information sources can be used within the scope of the illustrative embodiments. Query repository 111 is any suitable manner of storing or providing one or more original queries to application 105. Unstructured data 113 is usable in conjunction with application 105 as described in this disclosure.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments. Data processing system 200 is also representative of other devices in which computer usable program code or instructions implementing the processes of the illustrative embodiments may be located. Data processing system 200 is described as a computer only as an example, without being limited thereto. Implementations in the form of other devices may modify data processing system 200 and even eliminate certain depicted components there from without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105, and NLP engine 107 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

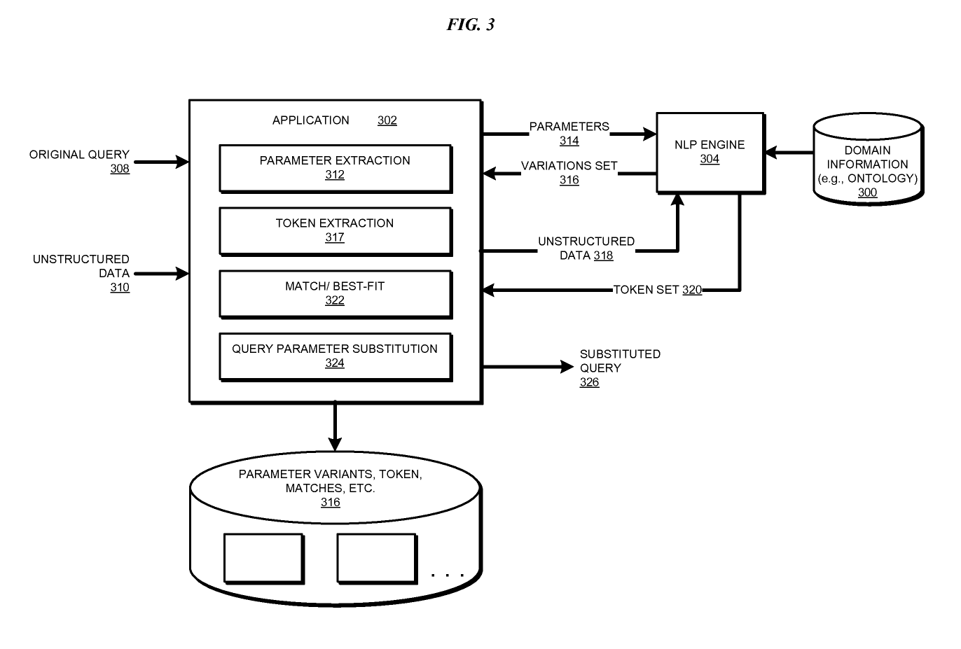

With reference to FIG. 3, this figure depicts an example configuration for unstructured data guided query modification in accordance with an illustrative embodiment. Application 302 is an example of application 105 in FIG. 1. NLP engine is an example of NLP engine 107 in FIG. 1. Domain information 306 is an example of domain information 109 in FIG. 1 and is available to NLP engine 304 from any suitable source or repository, such as storage 108 in FIG. 1. Original query 308 is an original query from query repository 111 in FIG. 1. Unstructured data 310 is an example of unstructured data 113 in FIG. 1.

Application receives original query 308 as input. Component 312 extracts a set of parameters from original query 308. Application 302 sends (314) all or part of the set of parameters, serially or parallel, to NLP engine 304. NLP engine determines a set of variations corresponding to each parameter received from application 302 using domain information 306. NLP engine 304 returns (316) the sets of variations to application 302.

Optionally, application 302 may store a parameter and a corresponding set of variations in repository 316. Repository 316 is usable for obtaining the set of variations in the future, for example, when the same parameter is present in another original query in the same domain.

Application receives unstructured data 310 as input. Component 317 extracts a set of tokens from unstructured data 310, such as by sending (318) all or part of unstructured data 310 to NLP engine 304. NLP engine identifies a set of tokens in the received unstructured data using domain information 306. NLP engine 304 returns (320) a set of tokens to component 314.

Optionally, application 302 may store a token in repository 316. Repository 316 is usable for identifying the token in the future, for example, in another unstructured data in the same domain.

Component 322 matches a token from the token set to a variant in a set of variations of a parameter. Component 322 finds an exact match, a singular fit within a tolerance, or a best fitting variant amongst multiple fitting variants for a given token.

Component 324 substitutes a parameter in original query 308 with the variant identified for that parameter by component 322. Application outputs substitute query 326. Substitute query 326 maintains the logic and structure of original query 308 but substitutes one or more parameters of original query 308 with corresponding one or more variants.

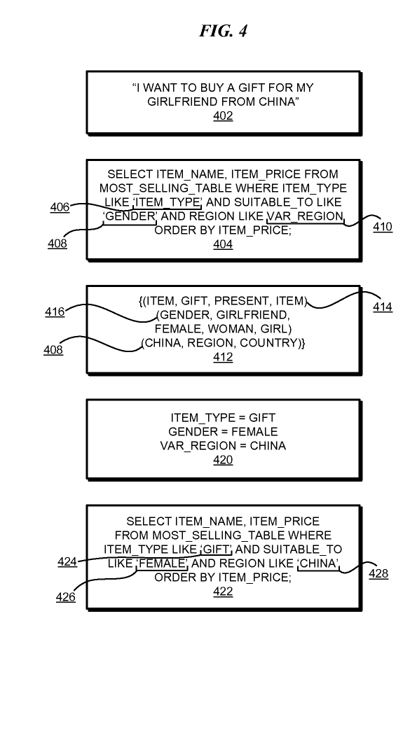

With reference to FIG. 4, this figure depicts a block diagram of an example unstructured data guided query modification in accordance with an illustrative embodiment. The operations depicted in this figure can be performed using application 302 in FIG. 3.

Block 402 shows an example unstructured data provided by a user, for example, “I want to buy a gift for my girlfriend from China.” Block 404 shows an example original query. Original query 404 includes example parameter 406 “item_type”, parameter 408 “gender”, and parameter “var_region”. Original query 404 also includes other parameters, such as “item_price”.

Block 412 shows sets of variations generated by application 302 corresponding to a subset of parameters in original query 404. For example, set 414 corresponds to parameter 406, set 416 corresponds to parameter 408, and set 418 corresponds to parameter 410.

Block 420 shows various fitting variants selected by application 302 from various sets of variations in block 412. For example, parameter 406 “item_type” has a fitting variation “gift”, parameter 408 “gender” has a fitting variation “female”, and parameter 410 “var_region” has a fitting variation “China”.

Block 422 shows a substituted query output from application 302. Substituted query 422 includes the logic and structure of original query 402, but substitutes parameters 406, 408, and 410 therein with the fitting variations of block 420. Substituted query 422 when executed on a database will produce a result set that would be relevant to the transient or dynamic interest or expectation expressed in the unstructured data of block 402, to wit, the user's intention of buying a gift for a female friend from China.

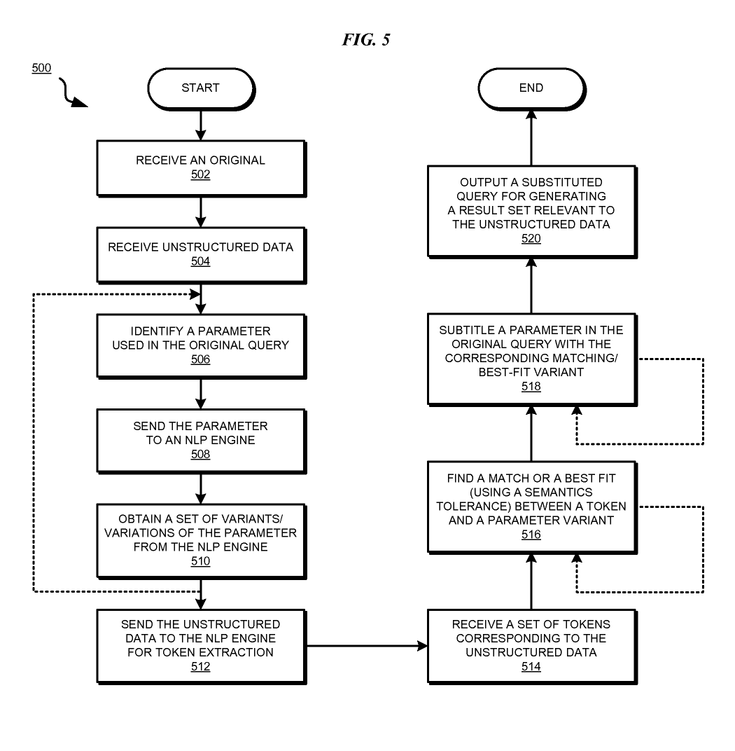

With reference to FIG. 5, this figure depicts a flowchart of an example process for unstructured data guided query modification in accordance with an illustrative embodiment. Process 500 can be implemented in application 302 in FIG. 3.

The application receives an original query (block 502). The application receives unstructured data (block 504).

The application identifies a parameter used in the original query (block 506). The application sends the parameter to an NLP engine (block 508). The application obtains a set of variations corresponding to the parameter from the NLP engine (block 510).

The application repeats blocks 506, 508, and 510 as many times as the number of parameters for which variants are desired. In one embodiment, block 506 identifies all such parameters; block 508 sends all such parameters, and block 510 receives all sets of variations for such parameters, obviating iterative execution of blocks 506, 508, and 510.

The application sends the unstructured data of block 504 to the NLP engine (block 512). The application receives from the NLP engine a set of tokens corresponding to the unstructured data (block 514).

The application finds a match, a fit, or a best fit, such as by using a semantic tolerance, between a token and a parameter variant (block 516). The application repeats block 516 for as many fits as can be found between the set of tokens and the sets of variations.

The application substitutes a parameter in the original query with the corresponding matching, fitting, or best fitting variant (block 518). The application repeats block 518 for as many substitutions as the number of fits found between the set of tokens and the sets of variations.

The application outputs a substituted query (block 520). The application ends process 500 thereafter. The substituted query of block 520 can be used to generate a result set that is relevant to the unstructured data in the manner described elsewhere in this disclosure.

Thus, a computer implemented method, system or apparatus, and computer program product are provided in the illustrative embodiments for unstructured data guided query modification.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for unstructured data guided query modification, the method comprising:
identifying, using a processor and a memory, a set of parameters in a structured database query;
identifying, using a Natural language processing (NLP) engine, a set of tokens in an unstructured data;
obtaining, using the NLP engine, corresponding to a subset of the set of parameters, sets of variations, wherein a particular set of variations corresponds to a particular parameter in the subset of parameters;
finding a fit between a first token from the set of tokens and a first variant of a first parameter, the first variant of the first parameter being a member of a first set of variations corresponding to the first parameter; and
substituting the first parameter in the structured database query with the first variant to produce a substituted query, wherein the substituted query produces a result set that is related to the unstructured data.

2. The method of claim 1, further comprising:
omitting substituting a second parameter in the structured database query such that the second parameter remains unchanged from the structured database query to the substituted query, wherein the second parameter is another member of the set of parameters, and wherein the omitting is responsive to a second token not fitting any variants in a second set of variants corresponding to the second parameter.

3. The method of claim 1, further comprising:
omitting substituting a second parameter in the structured database query such that the second parameter remains unchanged from the structured database query to the substituted query, wherein the second parameter is not a member of the set of parameters.

4. The method of claim 1, further comprising:
comparing the first token with a plurality of variants in the first set of variations corresponding to the first parameter;
determining that the first token matches the first variant to a first degree according to a specified tolerance;
determining that the first token matches a second variant in the first set of variations to a second degree according to the tolerance; and
selecting, responsive to the first degree exceeding the second degree, the first variant.

5. The method of claim 1, wherein a set of variations is specific to a subject-matter domain to which the unstructured data relates, different unstructured data relate to different subject-matter domains, and the different subject-matter domains result in different sets of variations for a given parameter in the subset of parameters.

6. The method of claim 1, further comprising:
obtaining the unstructured data from an interaction of a user, wherein the unstructured data is indicative of a transient interest of the user, the transient interest being a factor of a circumstance of the user at a time when the user uses the unstructured data.

7. The method of claim 6, wherein the interaction occurs in a social media environment, wherein the transient interest is distinct from a preference of the user, the preference being identified in a structured profile of the user, and wherein the circumstance is an event occurring relative to the user at the time.

8. The method of claim 1, wherein the method is embodied in a computer program product comprising one or more computer-readable tangible storage devices and computer-readable program instructions which are stored on the one or more computer-readable tangible storage devices and executed by one or more processors.

9. The method of claim 1, wherein the method is embodied in a computer system comprising one or more processors, one or more computer-readable memories, one or more computer-readable tangible storage devices and program instructions which are stored on the one or more computer-readable tangible storage devices for execution by the one or more processors via the one or more memories and executed by the one or more processors.

10. A computer program product for unstructured data guided query modification, the computer program product comprising:
one or more computer-readable tangible storage devices;
program instructions, stored on at least one of the one or more storage devices, to identify, using a processor and a memory, a set of parameters in a structured database query;
program instructions, stored on at least one of the one or more storage devices, to identify, using a Natural language processing (NLP) engine, a set of tokens in an unstructured data;
program instructions, stored on at least one of the one or more storage devices, to obtain, using the NLP engine, corresponding to a subset of the set of parameters, sets of variations, wherein a particular set of variations corresponds to a particular parameter in the subset of parameters;
program instructions, stored on at least one of the one or more storage devices, to find a fit between a first token from the set of tokens and a first variant of a first parameter, the first variant of the first parameter being a member of a first set of variations corresponding to the first parameter; and
program instructions, stored on at least one of the one or more storage devices, to substitute the first parameter in the structured database query with the first variant to produce a substituted query, wherein the substituted query produces a result set that is related to the unstructured data.

11. The computer program product of claim 10, further comprising:
program instructions, stored on at least one of the one or more storage devices, to omit substituting a second parameter in the structured database query such that the second parameter remains unchanged from the structured database query to the substituted query, wherein the second parameter is another member of the set of parameters, and wherein the omitting is responsive to a second token not fitting any variants in a second set of variants corresponding to the second parameter.

12. The computer program product of claim 10, further comprising:
program instructions, stored on at least one of the one or more storage devices, to omit substituting a second parameter in the structured database query such that the second parameter remains unchanged from the structured database query to the substituted query, wherein the second parameter is not a member of the set of parameters.

13. The computer program product of claim 10, further comprising:
program instructions, stored on at least one of the one or more storage devices, to compare the first token with a plurality of variants in the first set of variations corresponding to the first parameter;
program instructions, stored on at least one of the one or more storage devices, to determine that the first token matches the first variant to a first degree according to a specified tolerance;
program instructions, stored on at least one of the one or more storage devices, to determine that the first token matches a second variant in the first set of variations to a second degree according to the tolerance; and
program instructions, stored on at least one of the one or more storage devices, to select, responsive to the first degree exceeding the second degree, the first variant.

14. The computer program product of claim 10, wherein a set of variations is specific to a subject-matter domain to which the unstructured data relates, different unstructured data relate to different subject-matter domains, and the different subject-matter domains result in different sets of variations for a given parameter in the subset of parameters.

15. The computer program product of claim 10, further comprising:
program instructions, stored on at least one of the one or more storage devices, to obtain the unstructured data from an interaction of a user, wherein the unstructured data is indicative of a transient interest of the user, the transient interest being a factor of a circumstance of the user at a time when the user uses the unstructured data.

16. The computer program product of claim 15, wherein the interaction occurs in a social media environment, wherein the transient interest is distinct from a preference of the user, the preference being identified in a structured profile of the user, and wherein the circumstance is an event occurring relative to the user at the time.

17. A computer system for unstructured data guided query modification, the computer system comprising:
one or more processors, one or more computer-readable memories and one or more computer-readable tangible storage devices;
program instructions, stored on at least one of the one or more storage devices for execution by at least one of the one or more processors via at least one of the one or more memories, to identify, using a processor and a memory, a set of parameters in a structured database query;
program instructions, stored on at least one of the one or more storage devices for execution by at least one of the one or more processors via at least one of the one or more memories, to identify, using a Natural language processing (NLP) engine, a set of tokens in an unstructured data;
program instructions, stored on at least one of the one or more storage devices for execution by at least one of the one or more processors via at least one of the one or more memories, to obtain, using the NLP engine, corresponding to a subset of the set of parameters, sets of variations, wherein a particular set of variations corresponds to a particular parameter in the subset of parameters;
program instructions, stored on at least one of the one or more storage devices for execution by at least one of the one or more processors via at least one of the one or more memories, to find a fit between a first token from the set of tokens and a first variant of a first parameter, the first variant of the first parameter being a member of a first set of variations corresponding to the first parameter; and
program instructions, stored on at least one of the one or more storage devices for execution by at least one of the one or more processors via at least one of the one or more memories, to substitute the first parameter in the structured database query with the first variant to produce a substituted query, wherein the substituted query produces a result set that is related to the unstructured data.

18. The computer system of claim 17, further comprising:
program instructions, stored on at least one of the one or more storage devices for execution by at least one of the one or more processors via at least one of the one or more memories, to omit substituting a second parameter in the structured database query such that the second parameter remains unchanged from the structured database query to the substituted query, wherein the second parameter is another member of the set of parameters, and wherein the omitting is responsive to a second token not fitting any variants in a second set of variants corresponding to the second parameter.

19. The computer system of claim 17, further comprising:
program instructions, stored on at least one of the one or more storage devices for execution by at least one of the one or more processors via at least one of the one or more memories, to omit substituting a second parameter in the structured database query such that the second parameter remains unchanged from the structured database query to the substituted query, wherein the second parameter is not a member of the set of parameters.

20. The computer system of claim 17, further comprising:
program instructions, stored on at least one of the one or more storage devices for execution by at least one of the one or more processors via at least one of the one or more memories, to compare the first token with a plurality of variants in the first set of variations corresponding to the first parameter;
program instructions, stored on at least one of the one or more storage devices for execution by at least one of the one or more processors via at least one of the one or more memories, to determine that the first token matches the first variant to a first degree according to a specified tolerance;
program instructions, stored on at least one of the one or more storage devices for execution by at least one of the one or more processors via at least one of the one or more memories, to determine that the first token matches a second variant in the first set of variations to a second degree according to the tolerance; and
program instructions, stored on at least one of the one or more storage devices for execution by at least one of the one or more processors via at least one of the one or more memories, to select, responsive to the first degree exceeding the second degree, the first variant.
